(19) United States
(12) Patent Application Publication
(10) Pub. No.: US 2018/0092040 A1
(43) Pub. Date: Mar. 29, 2018

(54) USER DEVICE, NETWORK NODE AND METHODS THEREOF

(71) Applicant: HUAWEI TECHNOLOGIES CO., LTD., Shenzhen (CN)

(72) Inventors: Kari HEISKA, Helsinki (FI); Antti IMMONEN, Kista (SE); Xavier GELABERT, Kista (SE)

(21) Appl. No.: 15/825,020

(22) Filed: Nov. 28, 2017

Related U.S. Application Data
(63) Continuation of application No. PCT/EP2015/061938, filed on May 29, 2015.

(51) Int. Cl. H04W 52/02; H04W 76/04; H04W 72/04

(52) U.S. Cl. CPC H04W 52/0235; H04W 76/06; H04W 72/0406; H04W 76/048

(57) ABSTRACT

The present invention relates to a user device and a network node. The user device (100) comprises a processor (102), and a transceiver (104); wherein the processor (102) is configured to: operate the transceiver (104) in a first mode of operation (M1) in which the transceiver (104) is configured to receive Radio Frequency, RF, signals and to transmit RF signals; or operate the transceiver (104) in a second mode of operation (M2) in which the transceiver (104) is configured to transmit RF signals and not to receive RF signals.

### CROSS-REFERENCE TO RELATED APPLICATIONS

This application is a continuation of International Application No. PCT/EP2015/061938, filed on May 29, 2015, the disclosure of which is hereby incorporated by reference in its entirety.

### TECHNICAL FIELD

The present invention relates to a user device and a network node. Furthermore, the present invention also relates to corresponding methods, a computer program, and a computer program product.

### BACKGROUND

The power consumption in wireless modems of user devices (e.g. a User Equipment, UE) can generally be divided into fixed power consumption and variable power consumption. The fixed power consumption consists of the power needed for maintaining the subsystems, such as Radio Frequency (RF) subsystem and Baseband (BB) subsystem, and keep the subsystems in idle mode. The variable power consumption consists of power needed to receive, transmit, code/decode, detect and process signals.

The fixed part of the power consumption is relatively high which means high power consumption also in the case of low data rates. Due to high fixed power consumption current cellular systems employ Discontinuous Reception and Transmission (DRX/DTX or DTRX) operation modes which means that the subsystem(s) of the wireless modems are switched off during periods with no reception or transmission.

The power consumption of smart-phones is expected to grow in the future due to increased amount of traffic and due to increased usage time. With Machine-to-Machine (M2M) devices, on the contrary, the traffic volumes will be low and the power consumption will be dominated by the idle time power consumption. In the future, wireless communication systems will be equipped with in-built positioning technology. With the moving M2M wireless modems with real time position tracking the power consumption is even more severe due to frequent positioning signalling.

The DTRX functionality saves energy of the user device by switching the transceiver off during the time when there is no data to be transmitted or received. In the Connected Mode DRX the user device is scheduled periodically so the user device knows when to be active and when to sleep. The radio network can also specify for how long the user device can be ON during each period and for how long the user device should be ON after successfully decoding data.

In 3GPP Long Term Evolution (LTE) there are two UE stages: RRC_IDLE and RRC_CONNECTED, and the DRX functionality can be configured for both of these stages. The radio network controls the DRX mechanisms by sending either UE or Cell specific DRX parameters. The UE uses cell specific DRX parameters broadcasted via the system information block 2 (SIB2) signalling or UE specific DRX parameters via NAS signalling. However, once receiving the parameters related to DRX/DTX functionality the UE is autonomous and is able to switch on/off itself accordingly.

The wireless modem also utilizes deep sleep and light sleep modes. In this context the wireless modem comprises of RF subsystem and baseband subsystem. During the deep sleep mode the wireless modem is almost completely off and its power consumption is at low level, e.g. only couple of milliwatts. During the light sleep mode the wireless modem has switched off its RF subsystem but the baseband subsystem and some other functionalities remain active. The wireless modem utilizes the deep sleep mode if the parameter DRX cycle is above a certain threshold and light sleep otherwise. The wireless modem wakes up periodically following the DRX cycle parameter set by the radio network as discussed above. The threshold between deep sleep and light sleep activation is also set by the radio network.

Disadvantage or drawbacks of conventional solutions is that the entire wireless modem has to be activated even when sending a small packet typically for control purposes, either resource control or mobility control. In the case of deep sleep cycle the wireless modem is active over a long period since it starts from the low power mode. In the case of light sleep the active period is shorter since the wireless modem is activating only some of its functionalities and the synchronization time is lower compared to the synchronization time in deep sleep mode. However, the power consumption of the light sleep is high mainly due to “always on” baseband subsystem leading to high average powers.

### SUMMARY

An objective of embodiments of the present invention is to provide a solution which mitigates or solves the drawbacks and problems of conventional solutions.

An “or” in this description and the corresponding claims is to be understood as a mathematical OR which covers “and” and “or”, and is not to be understood as an XOR (exclusive OR).

The above objectives are solved by the subject matter of the independent claims. Further advantageous implementation forms of the present invention can be found in the dependent claims.

According to a first aspect of the invention, the above mentioned and other objectives are achieved with a user device for a wireless communication system, the user device comprising
a processor, and
a transceiver;
wherein the processor is configured to:

operate the transceiver in a first mode of operation in which the transceiver is configured to receive Radio Frequency, RF, signals and to transmit RF signals; or

operate the transceiver in a second mode of operation in which the transceiver is configured to transmit RF signals and not to receive RF signals.

Therefore, the processor is configured to control and operate the transceiver in a first mode of operation and the second mode of operation. With this functionality a number of advantages are provided by the user device according to the first aspect.

One such advantage is the possibility to categorize the transmission and/or reception needs by their direction, e.g. either in the uplink or the downlink, the end user device service type, the needed baseband processing capacity, etc. By selecting the most appropriate operation mode adapted to the categorization the power consumption of the transceiver can be optimized.

In a first possible implementation form of the user device according to first aspect, the transceiver, in the first mode of operation, is configured to

receive a first control signal comprising an operation mode command indicating the first mode of operation or the second mode of operation; and the processor further is configured to

operate the transceiver in the first mode of operation or in the second mode of operation according to the operation mode command.

The network node and/or its associated radio network can therefore control the operation mode of the user device for optimizing power consumption in the user device. For example, the network node(s) may measure the quality of the received signals from the user device and configure the mode of operation of the user device based on these measurements by sending the operation mode command to the user device. Also, further radio network related issues, such as mobility and interference, can be considered for controlling the mode of operation of the user device thereby optimizing the power consumption even more.

In a second possible implementation form of the user device according to the first possible implementation form of the first aspect or to the first aspect as such, the RF signals are beacon signals.

In the case when the RF signals are beacon signals the needed processing can be optimised since beacon signals may not always require complex baseband processing. Beacon signals can also be used for terminal positioning purposes which may lead to very frequent beacon transmissions in some cases. Therefore, the possibility of switching between the first and the second modes of operation for beacon signal transmissions gives considerable advantage in respect of the user device power consumption.

In a third possible implementation form of the user device according to the second possible implementation form of the first aspect,

the transceiver, in the first mode of operation, is configured to receive an allocation signal comprising at least one resource allocation parameter, and

the transceiver, in the second mode of operation, is configured to transmit the beacon signals based on the resource allocation parameter.

The beacon signal resource allocation is therefore controlled by the radio network which is able to optimize the overall performance of the beacon signal transmission and reception. The first mode of operation has more capabilities than the second mode of operation and therefore it is beneficial that the allocation signal is received when the transceiver is operating in the first mode of operation.

In a fourth possible implementation form of the user device according to any of the preceding possible implementation forms of the first aspect or to the first aspect as such, the first mode of operation is a discontinuous reception and discontinuous transmission, DRX and DTX, mode, and wherein the second mode of operation is a DTX mode.

In the first mode of operation the transceiver is able to receive the allocations and in the second mode of operation the transceiver is only able to transmit. It is therefore possible to optimize the second mode of operation for DTX transmission only functionalities and therefore to minimize the overall power consumption of the user device.

In a fifth possible implementation form of the user device according to the fourth possible implementation form of the first aspect, the transceiver, in the first mode of operation, is configured to receive a second control signal comprising at least one parameter in the group comprising: cyclic time period for the DRX and DTX mode, number of cyclic time periods for the DRX and DTX mode, cyclic time period for the DTX mode, and number of cyclic time periods for the DTX mode.

During the first mode of operation the transceiver is able to receive DTX and/or DRX configuration parameters. These configuration parameters can be used for the second mode of operation, and can be valid during the time the transceiver is operating in the second mode of operation. The radio network is able to configure the above mentioned DTX and/or DRX parameters in such a way that the overall transmission and reception performance is optimized.

In a sixth possible implementation form of the user device according to any of the preceding possible implementation forms of the first aspect or to the first aspect as such,

the transceiver, in the first mode of operation, is configured to provide a base band signal,

the transceiver is configured to upconvert the base band signal to a RF signal,

the transceiver, in the second mode of operation, is configured to transmit the upconverted base band signal.

In this implementation form the transceiver during the second mode of operation is only transmitting the RF signal. This option optimises the computational complexity of the transmission. This is applicable only when the signal to be transmitted is known beforehand during the first mode of operation which means that the transceiver in the first mode of operation provide and upconvert a baseband signal for transmission in the second mode of operation.

According to a second aspect of the invention, the above mentioned and other objectives are achieved with a network node for a wireless communication system, the network node comprising:

a processor configured to determine a first mode of operation or a second mode of operation for a user device, wherein the user device in the first mode of operation is configured to receive and transmit RF signals and in the second mode of operation is configured to transmit RF signals and not to receive RF signals;

a transceiver configured to transmit a first control signal to the user device, the first control signal comprising an operation mode command indicating the determined first mode of operation or the second mode of operation.

A number of advantages are provided a network node having the capabilities a network node according to the second aspect.

The network node and/or its associated radio network is able to control the operation mode of the user device for optimizing power consumption in the user device. For example, the network node(s) may measure the quality of the received signals from the user device and configure the mode of operation of the user device based on these measurements by sending the operation mode command to the user device. Also, further radio network related issues, such as mobility and interference, can be considered for controlling the mode of operation of the user device thereby optimizing the power consumption even more.

In a first possible implementation form of the network node according to second aspect,

the transceiver further is configured to receive beacon signals from the user device;

the processor further is configured to determine at least one resource allocation parameter based on at least one measurement of the beacon signals;

the transceiver further is configured to transmit an allocation signal to the user device, the allocation signal comprising the resource allocation parameter.

The beacon signal resource allocation is therefore controlled by the network node which is able to optimize the overall performance of the beacon signal transmission and reception.

In a second possible implementation form of the network node according to the first possible implementation form of the second aspect,

the transceiver further is configured to receive at least one other measurement from other network nodes, the other measurement being associated with the beacon signals from the user device;

the processor further is configured to determine the resource allocation parameter based on the measurement and the other measurement.

By combining measurements from several other network nodes it is possible to improve the quality of measurements further and make more accurate parameterization of the user device. The other measurements from the other network nodes improve the quality of the parameterization especially in the case of fast moving user devices with high positioning requirements.

In a third possible implementation form of the network node according to any of the preceding possible implementation forms of the second aspect or to the second aspect as such, the first mode of operation is a DRX and DTX mode and the second mode of operation is a DTX mode;

the processor further is configured to determine at least one DTX parameter;

the transceiver further is configured to transmit a second control signal to the user device, the second control signal comprising the DTX parameter.

With this possible implementation form the radio network can control and optimize the DTX transmission of the user device. Especially, the second mode of operation for DTX transmission only functionalities for the user device can be optimized meaning reduced overall power consumption in the user device.

In a fourth possible implementation form of the network node according to the third possible implementation form of the second aspect, the transceiver further is configured to signal the DTX parameter to other network nodes.

With this possible implementation form the network nodes of the radio network can be coordinated in respect of DTX transmissions by the user device. For example, by knowing the DTX parameters the other network nodes can assists the network node in receiving DTX transmission from the user device.

According to a third aspect of the invention, the above mentioned and other objectives are achieved with a method for a user device comprising a transceiver, the method comprising:

operating the transceiver in a first mode of operation in which the transceiver is configured to receive and transmit RF signals, or

operating the transceiver in a second mode of operation in which the transceiver is configured to transmit RF signals and not to receive RF signals.

In a first possible implementation form of the method according to third aspect, the method, when the transceiver is in the first mode of operation, further comprises

receiving a first control signal comprising an operation mode command indicating the first mode of operation or the second mode of operation; and

operating the transceiver in the first mode of operation or in the second mode of operation according to the operation mode command.

In a second possible implementation form of the method according to the first possible implementation form of the third aspect or to the third aspect as such, the RF signals are beacon signals.

In a third possible implementation form of the method according to the second possible implementation form of the third aspect, the method when the transceiver is in the first mode of operation, further comprises

receiving an allocation signal comprising at least one resource allocation parameter, and when the transceiver is in the second mode of operation, further comprises

transmitting the beacon signals based on the resource allocation parameter.

In a fourth possible implementation form of the method according to any of the preceding possible implementation forms of the third aspect or to the third aspect as such, the first mode of operation is a discontinuous reception and discontinuous transmission, DRX and DTX, mode, and wherein the second mode of operation is a DTX mode.

In a fifth possible implementation form of the method according to the fourth possible implementation form of the third aspect, the method, when the transceiver is in the first mode of operation, further comprises

receiving a second control signal comprising at least one parameter in the group comprising: cyclic time period for the DRX and DTX mode, number of cyclic time periods for the DRX and DTX mode, cyclic time period for the DTX mode, and number of cyclic time periods for the DTX mode.

In a sixth possible implementation form of the method according to any of the preceding possible implementation forms of the third aspect or to the third aspect as such, the method, when the transceiver is in the first mode of operation, further comprises

providing a base band signal, the method further comprises

upconverting the base band signal to a RF signal, the method, when the transceiver is in the second mode of operation, further comprises

transmitting the upconverted base band signal.

According to a fourth aspect of the invention, the above mentioned and other objectives are achieved with a method for a wireless communication system, the method comprising:

determining a first mode of operation or a second mode of operation for a user device, wherein the user device in the first mode of operation is configured to receive and transmit RF signals and in the second mode of operation is configured to transmit RF signals and not to receive RF signals;

transmitting a first control signal to the user device, the first control signal comprising an operation mode command indicating the determined first mode of operation or the second mode of operation.

In a first possible implementation form of the method according to fourth aspect, the method further comprises

receiving beacon signals from the user device;

determining at least one resource allocation parameter based on at least one measurement of the beacon signals;

transmitting an allocation signal to the user device, the allocation signal comprising the resource allocation parameter.

In a second possible implementation form of the method according to the first possible implementation form of the fourth aspect, the method further comprises

receiving at least one other measurement from other network nodes, the other measurement being associated with the beacon signals from the user device;

determining the resource allocation parameter based on the measurement and the other measurement.

In a third possible implementation form of the method according to any of the preceding possible implementation forms of the fourth aspect or to the fourth aspect as such, the first mode of operation is a DRX and DTX mode and the second mode of operation is a DTX mode; and the method further comprises

determining at least one DTX parameter;

transmitting a second control signal to the user device, the second control signal comprising the DTX parameter.

In a fourth possible implementation form of the method according to the third possible implementation form of the fourth aspect, the method further comprises signalling the DTX parameter to other network nodes.

The advantages of the methods according to the third aspect or the fourth aspect are the same as those for the corresponding device claims according to the first and second aspects.

The present invention also relates to a computer program, characterized in code means, which when run by processing means causes said processing means to execute any method according to the present invention. Further, the invention also relates to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

Further applications and advantages of the present invention will be apparent from the following detailed description.

### BRIEF DESCRIPTION OF THE DRAWINGS

The appended drawings are intended to clarify and explain different embodiments of the present invention, in which:

FIG. 1 shows a user device according to an embodiment of the present invention;

FIG. 2 shows a method according to an embodiment of the present invention;

FIG. 3 illustrates the first mode and the second mode of operation;

FIG. 4 shows a further user device according to an embodiment of the present invention;

FIG. 5 shows a network node according to an embodiment of the present invention;

FIG. 6 shows another method according to an embodiment of the present invention;

FIG. 7 illustrates signalling between a user device, a network node and other network nodes;

FIG. 8 illustrates power consumption for using the first mode and the second mode of operation;

FIG. 9 illustrates signalling for setting parameters for the second mode of operation;

FIG. 10 illustrates the effect of DTX parameters (N and Tᵤ) on the link adaption, the position accuracy and the power consumption;

FIG. 11 shows power cycles; and

FIG. 12 shows average power consumption for different beaconing methods.

### DETAILED DESCRIPTION

Embodiments of the present invention relate to a user device, a network node, and methods thereof for wireless communication systems which will be described in the following description.

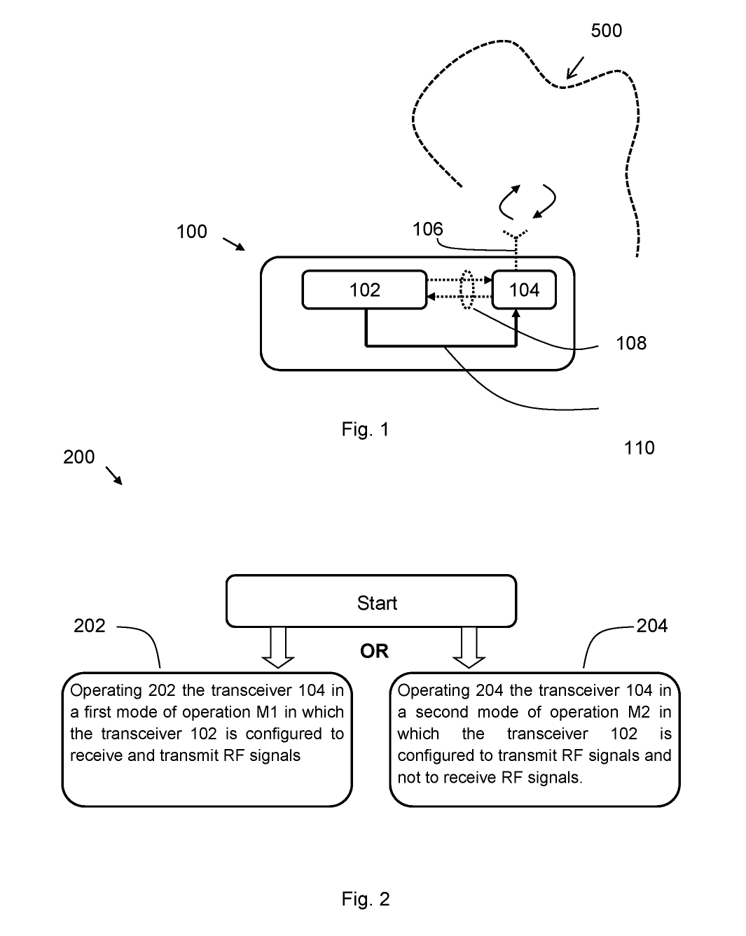

FIG. 1 shows a user device according to an embodiment of the present invention. The user device 100 comprises a processor 102 which is communicably coupled to a transceiver 104. The coupling means 108 are illustrated as dotted arrows in FIG. 1. The coupling means 108 are according to techniques known in the art. The coupling means 108 may e.g. be used for transfer of data and/or signalling between the processor 102 and the transceiver 104. The user device 100 further comprises control means 110 by which the processor 102 operates (or controls) the transceiver 104. The user device 100 also comprises antenna means 106 coupled to the transceiver for reception and transmission in the wireless communication system 500.

According to the present solution the processor 102 is configured to operate the transceiver 104 in at least two different modes. Therefore, the processor 102 is configured to operate the transceiver 104 in a first mode of operation M1 in which the transceiver 104 is configured to receive Radio Frequency (RF) signals and to transmit RF signals; or, the processor 102 is configured to operate the transceiver 104 in a second mode of operation M2 in which the transceiver 104 is configured to transmit RF signals and not to receive RF signals. In the second mode of operation M2 the transceiver is capable of transmitting any RF signals in the wireless communication system 500.

The expression RF signals should be understood in its broadest meaning and includes all types of wireless transmissions in RF bands.

FIG. 2 shows a flow chart of a corresponding method 200 for operation of a transceiver 104. The method 200 may be executed in a user device 100 comprising the transceiver 104, such as the one shown in FIG. 1. The method comprises the step of operating 202 the transceiver 104 in a first mode of operation M1 in which the transceiver 102 is configured to receive and transmit RF signals; or, the method 200 comprises the step of operating 204 the transceiver 104 in a second mode of operation M2 in which the transceiver 102 is configured to transmit RF signals and not to receive RF signals.

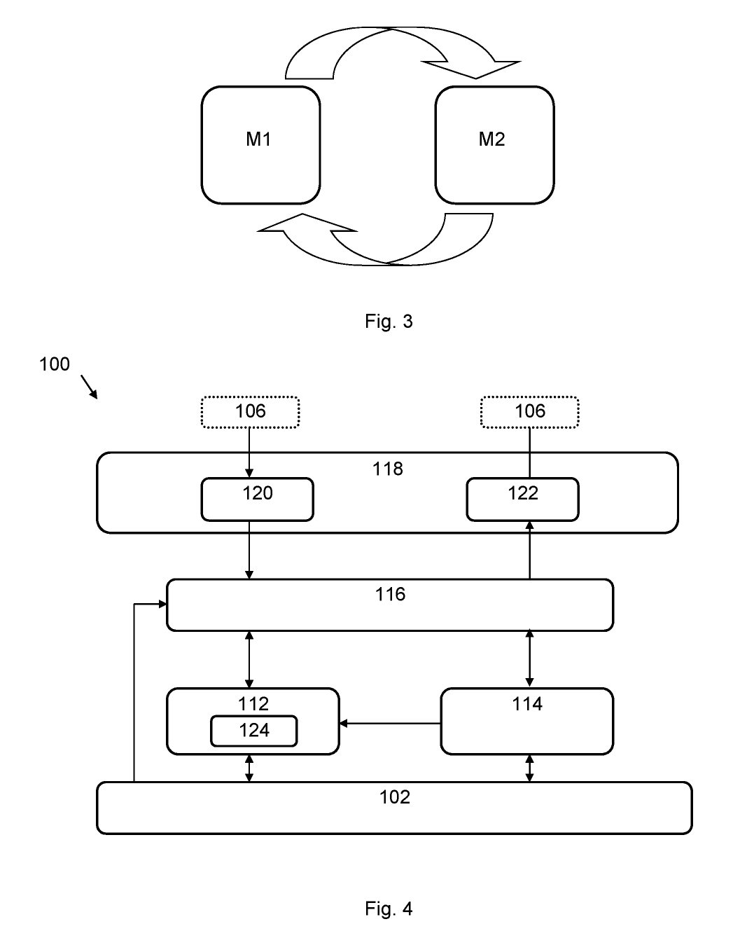

FIG. 3 shows a state diagram for how the transceiver operates according to the present solution. As shown the transceiver 104 may either be in the first mode of operation M1 or in the second mode of operation M2. Depending on different instructions the current state switches between states M1 and M2. It should however be noted that the transceiver 104 may also be configured to operate in further modes of operation as long as the first mode of operation M1 and the second mode of operation M2 are included.

FIG. 4 shows a user device 100 according to a further embodiment of the present invention. The transceiver 104, e.g. a wireless modem, includes a logical switch 116 which selects between a main BB unit 114 and a light BB unit 112. The light BB unit includes a memory unit 124 which can store waveform samples to be transmitted during the low energy mode, i.e. when the transceiver 104 is operating in the second mode of operation M2. The main BB unit 114 can send waveform samples to the light BB unit 112 during the basic energy mode, i.e. when the transceiver 104is operating in the first mode of operation M1.

As described above, the proposed user device 100 and method 200 assumes that the transceiver 104 can operate in the two energy modes, i.e. the basic energy mode also denoted as the first mode of operation M1 where it utilizes its main BB unit 114; and the low energy mode also denoted as the second mode of operation M2 where the light BB unit 112 is used. With this embodiment sending a RF signal does not require the transceiver 104 to go to active state but needs only the activation of the light BB unit 112. The light BB unit 112 is only capable of transmitting RF signals but not of receiving RF signals.

Further, in this particular example the light BB unit 112 includes functionalities which are needed for BB signal transmission in uplink and/or downlink direction. The exact functionalities depend on the implementation of the particular BB functionality. In the simplest form, the light BB unit 112 is responsible for receiving the BB signal from the main BB unit 114, storing the signal and forward the BB signal to the RF subsystem 118. The transceiver 104 also comprises a RF transmit module 122 and a RF receiving module 120. Both RF modules 120 and 122 are coupled to respective connections of the antenna 106. Suitable communication connections between the different components of the user device 100 are illustrated with arrows in FIG. 4.

During the first mode of operation M1 the main BB unit 114 receives commands controlling the DRX and/or DTX procedure. The main BB unit 114 sends the commands to the processor 102 which makes decision on selecting the light BB procedure according to pre-defined criteria. If the light BB procedure is selected the processor 102 sends a command to the switching unit 116 and to the light BB unit 112. According to the command the switching unit 116 selects RF signal flow from the light BB unit 112. The light BB unit 112 starts sending the stored RF signal from its memory unit 124. The memory unit 124 has received the stored RF signal from the main BB unit 114 before switching. The cyclic time periods and the overall time for the sending the RF signal is controlled with DTX parameters, such as the cyclic time period for the DTX mode, number of cyclic time periods for the DTX mode and number of cyclic time periods for the DTX mode.

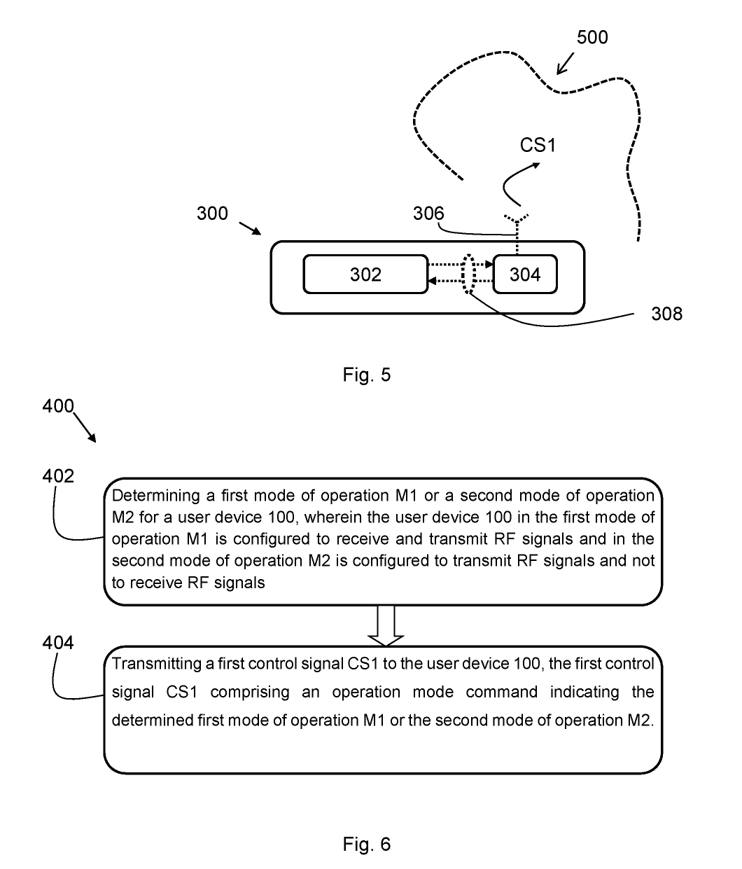

FIG. 5 shows a network node 300 according to an embodiment of the present invention. The network node 300 comprises a processor 302 communicably coupled with a transceiver 304 by means of communication means 308 (dotted arrows) known in the art. The communication means 308 may e.g. be used for transfer of data and control signalling between the processor 302 and the transceiver 304. The transceiver 304 is further coupled with an antenna 306 for wireless transmission and reception in the wireless communication system 500.

According to the present solution the processor 302 of the network node 300 is configured to determine a first mode of operation M1 or a second mode of operation M2 for a user device 100. As described above, the user device 100 in the first mode of operation M1 is configured to receive and transmit RF signals and in the second mode of operation M2 is configured to transmit RF signals and not to receive RF signals. The transceiver 304 of the network node 300 is configured to transmit a first control signal CS1 to the user device 100. The first control signal CS1 comprises an operation mode command indicating the determined first mode of operation M1 or the second mode of operation M2. The operation mode command may be included in a suitable message according to known or future communication protocols. The first control signal CS1 may be a dedicated downlink control signal for each connected user device of the radio network. The first control signal CS1 can be transmitted periodically or event triggered depending on application. The period for periodic transmission is a radio network planning parameter and will be set beforehand. The first control signal CS1 indicates the mode of the next period; i.e. either the first M1 or the second mode M2 of operation.

FIG. 6 shows a flow chart of a corresponding method 400. The method 400 may be executed in a network node 300, such as the one shown in FIG. 5. The method 400 comprises the step of determining 402 a first mode of operation M1 or a second mode of operation M2 for a user device 100. The user device 100 in the first mode of operation M1 is configured to receive and transmit RF signals. The user device 100 in the second mode of operation M2 is configured to transmit RF signals and not to receive RF signals. The method 400 further comprises the step of transmitting 404 a first control signal CS1 to the user device 100. The first control signal CS1 comprises an operation mode command indicating the determined first mode of operation M1 or the second mode of operation M2.

Therefore, in the embodiments described in FIGS. 5 and 6 of the network node 300, the radio network via one or more network nodes controls the operation of the energy mode of the user device 100. In this case, the radio network determines if the user device 100 should operate in the first mode M1 or the second mode M2 of operation.

Moreover, future radio networks are an ideal platform for delivering user device positioning service. The envisioned future radio networks are based on an Ultra Dense Network (UDN) topology which means that the distance between network nodes may be only some tens of meters. Therefore, for almost all outdoor locations there is a line-of-sight from the user device to many network nodes enabling very accurate estimation of the user device position. Also other technical characteristics of future radio networks, like wide bandwidth (200 MHz or more) and network node mounted antenna arrays support the high positioning accuracy. The accurate and frequent positioning estimate is needed when providing positioning services for moving vehicles, such as cars, robots and pedestrians.

However, in the positioning service, especially for M2M devices, the battery life-span has to be long, from several months to years without any charging or battery replacements. Thus, the transceiver 104 is switched on only when there is something to send or receive or when the user device needs to wake up for the incoming data packets.

For the positioning estimation the radio network centric method is considered herein, where the user device 100 transmits a beacon signal, received by one or more time-synchronized network nodes of the radio network. The radio network makes the positioning estimation and sends the result back to user device 100 if required. When transmitting the beacon signal the user device 100 needs to wake up, transmit the positioning beacon and go back again to sleep state or standby state. For that purpose the user device 100 needs to activate its reception chain, i.e. to synchronize with the radio network by receiving a synchronize signal, set its receive power levels, filter and sample the received signal and feed the signal to the baseband subsystem which take care of the detection, demodulation and decoding, etc. The power level of the signal varies according to the distance between the user device 100 and the network node 300. The receiver 104 will change its gain setting according to the received signal level. The activation of the baseband subsystem is also needed to generate the beacon signal, modulate, receive new allocated beacon resources (time, frequency, code, etc.) and to set the transmit power levels.

Currently, according to conventional techniques every time the user device 100 needs to send the beaconing signal the whole transceiver 104, i.e. the RF subsystem and the baseband subsystem, needs to be activated. The state-of-the-art transceiver 104s is not able to support low average power consumptions and required fast on-off power transitions.

Therefore, according to an embodiment of the present invention, the RF signals are beacon signals, and especially positioning beacon signals. The novel DTRX method enables fast transmissions of beacon information with low average power consumption together with fast power-on and power-off times.

Moreover, since the light BB unit 112 is considered to support uplink-only transmissions the link adaptation is not working during the low energy mode (M2). Therefore, a predictive link adaptation method is further presented in which the transmission parameters for the RF signal transmissions during the light BB operation (corresponding to the low energy mode M2) are computed and received by the transceiver 104 of the user device 100 when the transceiver 104 operates in the basic energy mode (M1).

In addition, the activation of the transceiver 104 is supported by the present solution. Typically, the transceiver 104 of the user device 100 switches itself to the active state to send data to/from the radio network and after that returns to sleep state. The DTX/DRX cycle is set by the radio network and the parameters related to DTX/DRX cycle are sent to the user device 100 according to this embodiment.

In the proposed solution the user device 100, when being in the active state, can utilize the two modes of operation M1 and M2, respectively. In the basic energy mode (corresponding to the first mode of operation M1) the transceiver 104 works in a normal way, such as it powers up the main BB to transmit and receive the data. However, in the low energy mode (corresponding to the second mode of operation M2) it is possible to support only limited number of functionalities as described above. Since the set of functionalities in the low energy mode (M2) are limited there should be assisted signalling between the network node(s) 300 and the user device 100 during the basic energy mode which are valid during the low energy mode according to further embodiments. The network node 300 is responsible for the validity of the used parameters and resource allocations.

In one embodiment of the present invention, this validity could be, for example, in the form of a time validity notified to the user device 100 during which the parameters and resource allocations are valid. This is more explained in the following disclosure.

In one embodiment of the present invention, a novel signalling interface which governs the power control and resource allocations for the beacon signals is presented. The signalling interface governs also the present DTRX cycles which depend e.g. on the speed of the user device 100, location, traffic load, etc. Hence, according to an embodiment of the present invention, the transceiver 104 of the user device 100, in the first mode of operation M1, is configured to receive an allocation signal comprising at least one resource allocation parameter for the beacon signals. The transceiver 104 is further, in the second mode of operation M2, configured to transmit the beacon signals based on the received resource allocation parameter.

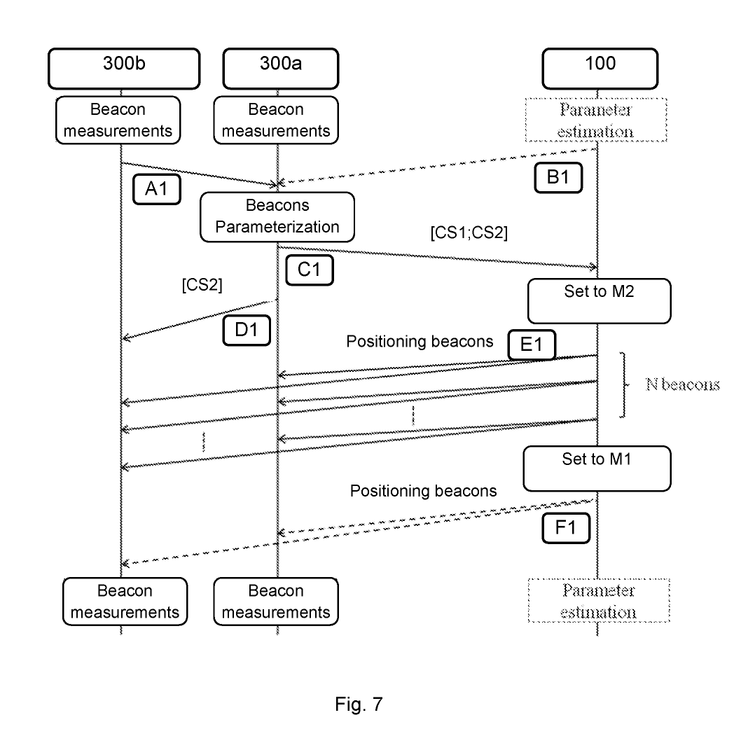

FIG. 7 shows the signalling flow according to the present proposed DTRX functionality. The serving network node 300a is responsible for the DTRX signalling to the user device 100, whereas another network node(s) 300b (there can be a plurality of other network nodes but only one such other network node is shown in FIG. 7) receiving the beacon signal transmitted by the user device 100 is responsible for the estimation of the beacon quality as well as the location, speed, pathloss estimations, etc for the user device 100. Since the beacon signals used for estimating these parameters can be received at multiple network nodes, there must be also information signalling exchange between receiving network nodes and the serving network node 300a in charge of signalling towards the user device 100. The parameters can be alternatively estimated also by user device 100 requiring corresponding uplink signalling from the user device 100 in question to the serving network node 300a. The serving network node 300a sets various parameters required to be used by the user device 100 in the proposed DTRX method during the light-BB operation (M2).

Since the transceiver 104 is without any downlink control link during the low energy operation mode, the serving network node 300a has to make sure that the power used for the beacon signals (notified to the user device 100 in the “Parameters” message) is at the right level and that there are enough signalling resources available during light-BB operation. This is due to unexpected change in pathloss and signalling capacity during light-BB operation, when the user device 100 is not able to receive updates on the downlink control channel. The power allocation depends on the maximum allowed pathloss for the beaconing as well as the assumed rate of change of the pathloss. The serving network node 300a sends this information to the user device 100 via downlink control signalling during basic-BB operation. The parameters contained in the parameters message are, but not limited to: transmission powers, subcarrier and time symbol allocations during the ON duration, number of ON durations in the DTX/DRX cycle, and length of the DTX/DRX cycle. The serving network node 300a may also want to send the DTRX information to the neighbouring network nodes which are expected to receive the beacons from the user device 100 in order to simplify the detection/decoding of the beacons.
With reference to FIG. 7:

At A1 another node(s) 300b sends the beacon measurements to the serving network node 300a;
In one embodiment, at B1, the user device 100 makes the assisting beacon signal parameter estimation itself and sends it in the uplink to the serving network node 300a. The serving network node 300a uses the beacon signal parameter estimation when doing the final beacon signal parameterization;
At C1 the serving network node 300a sends the control signal CS1 and CS2 to the user device 100 including the operation mode command and the DTX parameters, respectively;
At D1 the serving network node 300a sends the DTX parameters, e.g. in control signal CS2, to other network node(s) 300b to assist in beacon signal reception from the user device 100;
At E1, after the CS1 signal commands the user device 100 to use the second mode of operation M2 the user device 100 starts sending beacon signals in the second mode of operation M2. The cyclic time period for the DTX mode and the number of cyclic time periods for the DTX are defined in the CS2 signalling from the serving network node 300a;
At F1 the user device 100 can send the position beacon signals also after turning back to the first mode of operation M1. This can be used if e.g. energy consumption is not critical or if the radio channel changes very fast and it is not possible to rely on predefined position beacons in the second mode of operation M2.

The serving network node 300a may set the basic DTRX cycle parameters, Tₛ and Tᵤ, for the main BB and light-BB operation, respectively. Tₛ and Tᵤ are thus the DRX/DTX cycle for the first mode of operation M1 and the second mode of operation M2, respectively. These basic DTRX cycle parameters can also be sent in the second control signal CS2 in FIG. 7.

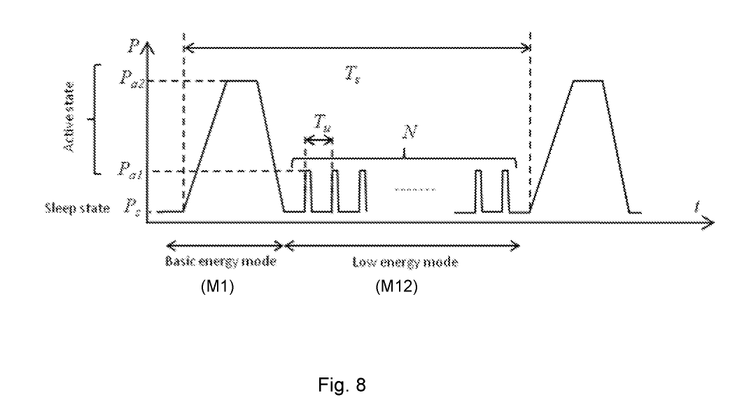

FIG. 8 shows the power consumption, P, in the user device 100 as a function of time, t, when sending beacon signals with DTX and DRTX cycles by using the two energy modes M1 or M2. The number of ON duration and the DTX cycle during the low energy mode, i.e. N and Tᵤ, respectively, are variables that can be set by the network node 300. For example, to adapt to a high speed of the user device 100 the network node 300 allocates resources more frequently (i.e. lower Tᵤ) to the user device 100 for a beacon signal transmission. The transceiver 104 returns to basic energy mode M1 following the cycle with Tₛ. Between subsequent basic energy modes the transceiver 104 goes to low energy mode following cycles given by Tᵤ. The number of low power beacon signal periods within Tₛ is N. The user device 100 switches between the different BB modules depending on the active mode (i.e. either basic or low energy modes). The values of Tₛ and Tᵤ are determined by the radio network and may depend on the required positioning accuracy, the received beacon quality or signal strength, speed or acceleration of the user device 100 (needed adaptation) as well as on the power saving targets, and further needs. When the transceiver 104 is in the sleep state all modules of the transceiver 104 are switched off and the power consumption is Pₛ as shown in FIG. 8. When the transceiver 104 is in its basic energy mode M1 the power consumption during active state is Pₐ₂ and when it is in low energy mode M2 the power consumption during active state is Pₐ₁.

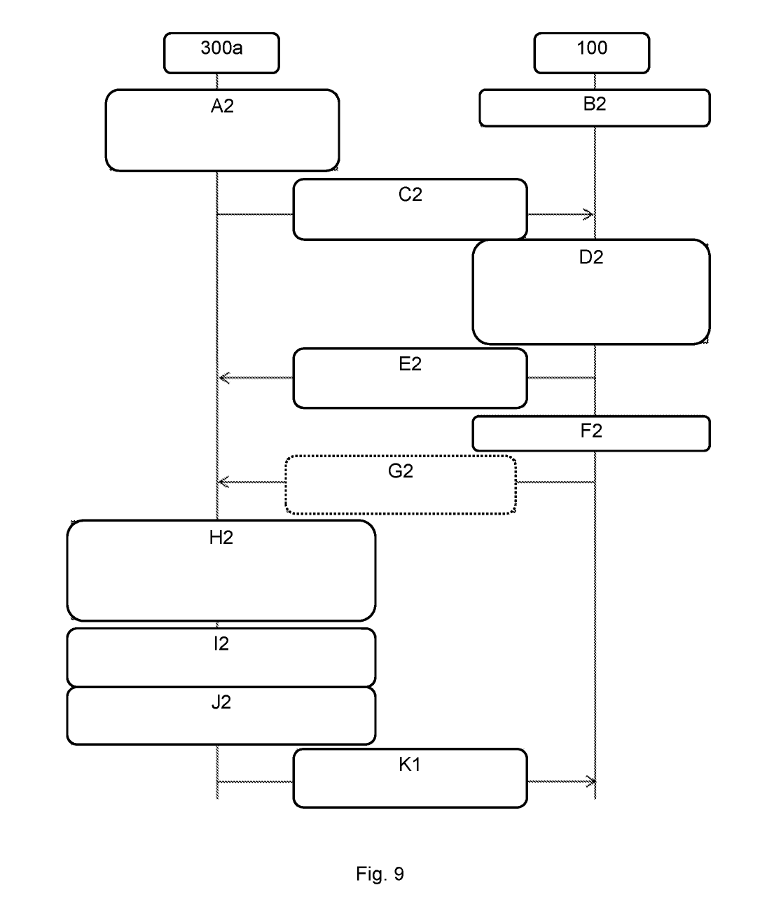

After switching to the low-energy mode M2 the user device 100 starts to send beacon signals from the light-BB with the pre-defined parameters and resource allocations. After sending the beacon signals, the user device 100 switches back to the basic energy mode M1 and switches on the main BB. After that the transceiver 104 synchronizes itself and decodes the downlink control channel. After that the transceiver 104 sends new beacon signals in basic energy mode to be used for mobility or positioning purposes. The transmission of the light BB is relying on the synchronization of the main BB during basic energy mode. The main BB is synchronizing the signal every Tₛ and the information on synchronization, e.g. the time adjustments will be sent from the main BB to the light BB. The synchronization of the transceiver 104 is maintained with internal clock. The power consumption of the clock even with a high accuracy is not seen as a problem but with stationary cases with long beacon interval even further, yet small, power saving could be achieved using low accuracy clock.
FIG. 9 illustrates an alternative beacon DTRX allocation algorithm including signalling between the network node 300 and the user device 100 which can be used with light BB operation. With reference to FIG. 9:
At A2 DTRX parameters for the low energy mode (M2) is defined, e.g. N=N₀, T_{U}=T_{U0}, P_{U}=P_{U0};
At B2 the user device 100 operates in the basic energy mode (M1);
At C2 the network node 300 transmits the DTRX parameters to the user device 100;
At D2 the user device 100 switches to the low energy mode (M2) and configures according to the received DTRX parameters;
At E2 the user device 100 sends N beacon signals to the network node(s) 300 in every T_{U};
At F2 the user device 100 returns to the basic energy node (M1);
At G2 the user device 100 optionally sends beacon signals in the basic energy mode (M1). The basic energy mode (M1) may be needed since during the low energy mode (M2) the user device 100 is without any network control since it is in uplink only mode. After sending N beacon signals the user device 100 turns itself into the basic energy mode (M1) and receives the control information from the network node 300. This control information can contain among other things the new DTX parameter values for the next low energy period (M2);
At H2 the network node 300 measures the quality of the received beacon signals. In this step the network node 300 may also receive measurements of the beacon signals from the user device 100 performed by other network nodes of the radio network;
At I2 the network nodes 300 checks the measured quality against quality criteria, e.g. threshold values;
At J2 the network node 300 set new and/or updates DTRX parameters based on the result in step I2; and
At K2 the network node 300 transmits the new and/or updated DTRX parameters to the user device 100.

In FIG. 9 DTRX parameters for the low energy mode beacon signal transmission are set as: N=the number of ON durations during low energy mode, Tᵤ=the DTX cycle during the low energy mode, and P_{U}=the transmission power for the low energy beacons. Instead of having a fixed number (N) of beacons DTRX during light BB operation the radio network, via one or more network nodes, can inform the user device 100 after light BB operation the quality of the received beacons (Q_Rx), estimation on position accuracy (Q_Pos) as well as the power consumption estimation (Q_P). After that the user device 100 switches itself to the low energy mode (M2) and starts sending low power beacon signals. The network node(s) 300 receives the beacons and measure the quality of the beacon signals (Q_Rx, Q_Pos and Q_P). Quality measures can, e.g. be signal strength, signal-to-noise-plus-interference ratio and/or possibly other measures. The network node 300 checks the number of transmitted low power beacon signals and/or the inter-beacon time Tᵤ in order to further increase the power efficiency.

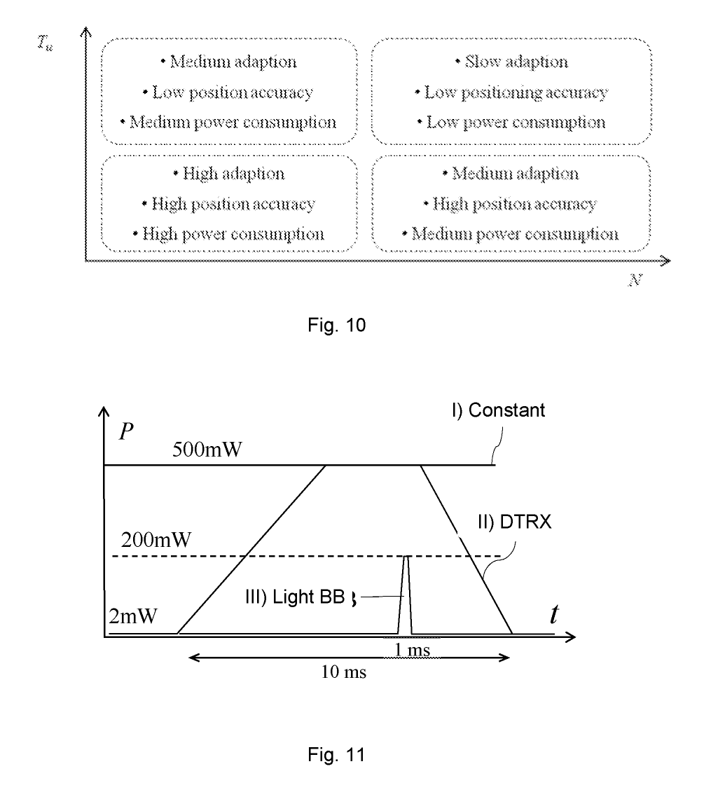

FIG. 10 illustrates the effect of the number of low power beacons periods (N) and inter-beacon time Tᵤ to the link adaption, the position accuracy and the terminal power consumption. With large N and Tᵤ the Tₛ will also be large since Tᵤ≈Tₛ·N leading to slow link adaptation, low position accuracy but also to low power consumption in the user device 100. On the other hand if the N is getting smaller keeping Tᵤ at high level the positioning the link adaption is getting better but the power consumption will increase. Decreasing the inter-beacon time Tᵤ improves the adaption and position accuracy but increases the power consumption as well. The beacon signal transmission here is comprised of one to several beacon signals having a specific time, frequency resource allocation inside a frame. However, this proposal does not consider the beacon signal and waveforms during one active period. There can be several subcarriers and several symbol periods allocated for beacon signals inside one beacon period. The properties of the positioning network shown in FIG. 10 can be designed by setting N and Tᵤ accordingly in the radio network.

As described above, future radio network, such as the 5G, will support accurate positioning based on user device 100 transmitted beacon signals. The accuracy of the positioning depends on the frequency of the beacon signal transmissions. The number of allocated beacon signal transmissions, their spectral characteristics and waveforms can be varied in order to enhance the position detection accuracy. The effect of the beacon signal transmission period to the average power consumption of the user device 100 is discussed here and illustrated in FIG. 11. It was assumed that the power consumption of the beacon signal transmission itself is 0 W (the assumed symbol period is 3.2 μs which is low compared to whole DTX cycle resulting a very low power) and all the power consumption comes from the power-up of the RF subsystem and BB subsystem. FIG. 11 shows the power consumption of the beaconing cycle of three methods compared here: constant power (I), DTRX (II) and light-BB (III). In the constant power method (I) no DRX/DTX is utilized but the subsystems use the total nominal power (500 mW) all the time. In the DTRX method (II) the DTRX cycle of 10 ms is used with the peak power of 500 mW. This corresponds to switch-on/off the whole transceiver 104. In the light-BB method (III) the maximum power of 200 mW is utilized with the DTRX cycle of 1 ms corresponding the power-up and power-down of RF sub-modules only. Power needed for RF sub-modules is assumed to be 200 mW and the power needed for RF sub-module +BB sub-module is 500 mW.

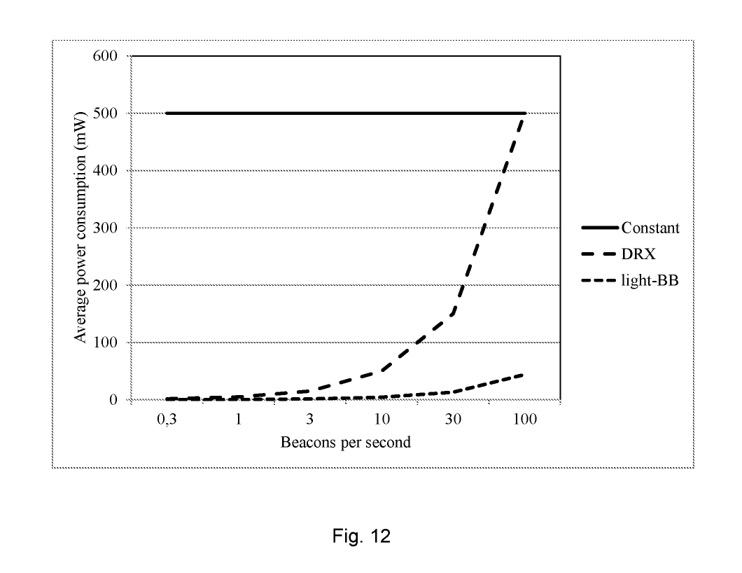

FIG. 12 shows performance results for the present solution, i.e. average power consumption of various beaconing methods as described above. The results shown in FIG. 12 indicate that with the present solution it is possible to significantly reduce the average power consumption in the user device 100.

In FIG. 12 the X-axis indicates the beaconing frequency i.e. how often user device 100 sends beacon signals and the Y-axis indicates the corresponding average power consumption of the user device 100. The “Constant” curve shows the average power consumption without any DRX/DTX and in this case the transceiver 104 is always on. The “DRX” curve shows the average power consumption if the DRX is used, so the modem is OFF during the times when there is no beacon signal to be transmitted. In the DRX case the transceiver 104 uses the basic energy mode including the effect of ramping up and down the normal BB which is very power consuming. In the light BB mode the normal BB modem is always OFF and only the RF module is ON during the DTX period.

It is possible to reduce the power consumption and the power transition times of the basic BB module. It requires, however, significant optimization of the whole wireless module platform and the architecture. The same wireless module supports legacy system so any big changes are challenging. As a reference, current LTE transceivers are not able to go into sleep mode with DRX cycles<≈40 ms. Thus improving legacy performance to allow sleep times of say a few ms would require substantial developments of already mature technology.

A user device 100 or a UE, mobile station, wireless terminal and/or mobile terminal is enabled to communicate wirelessly in a wireless communication system, sometimes also referred to as a cellular radio system. The User Equipment (UE) may further be referred to as mobile telephones, cellular telephones, computer tablets or laptops with wireless capability. The UEs in the present context may be, for example, portable, pocket-storable, hand-held, computer-comprised, or vehicle-mounted mobile devices, enabled to communicate voice and/or data, via the radio access network, with another entity, such as another receiver or a server. The UE can be a Station (STA), which is any device that contains an IEEE 802.11-conformant Media Access Control (MAC) and Physical Layer (PHY) interface to the Wireless Medium (WM).

A (radio) network node 300 or base station, e.g. a Radio Base Station (RBS), which in some networks may be referred to as transmitter, “eNB”, “eNodeB”, “NodeB” or “B node”, depending on the technology and terminology used. The radio network nodes may be of different classes such as e.g. macro eNodeB, home eNodeB or pico base station, based on transmission power and thereby also cell size. The radio network node can be a Station (STA), which is any device that contains an IEEE 802.11-conformant Media Access Control (MAC) and Physical Layer (PHY) interface to the Wireless Medium (WM).

Furthermore, any method according to the present invention may be implemented in a computer program, having code means, which when run by processing means causes the processing means to execute the steps of the method. The computer program is included in a computer readable medium of a computer program product. The computer readable medium may comprises of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that the present first network node and second network node comprises the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the present solution.

Especially, the processors of the present devices may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the present invention is not limited to the embodiments described above, but also relates to and incorporates all embodiments within the scope of the appended independent claims.

1. A user device in a wireless communication system, the user device comprising
a transceiver; and
a processor coupled with the transceiver, wherein the processor is configured to:
operate the transceiver in a first mode of operation in which the transceiver is configured to receive and transmit Radio Frequency (RF) signals; or
operate the transceiver in a second mode of operation in which the transceiver is configured to transmit RF signals and not to receive RF signals.

2. The user device according to claim 1, wherein the transceiver, in the first mode of operation, is configured to:
receive a first control signal comprising an operation mode command indicating the first mode of operation or the second mode of operation; and
wherein the processor is configured to:
operate the transceiver in the first mode of operation or in the second mode of operation according to the operation mode command.

3. The user device according to claim 1, wherein the RF signals are beacon signals.

4. The user device according to claim 3,
wherein the transceiver, in the first mode of operation, is configured to receive an allocation signal comprising at least one resource allocation parameter, and
wherein the transceiver, in the second mode of operation, is configured to transmit the beacon signals based on the resource allocation parameter.

5. The user device according to claim 1, wherein the first mode of operation is a discontinuous reception (DRX) and discontinuous transmission (DTX) mode, and the second mode of operation is a DTX mode.

6. The user device according to claim 5, wherein the transceiver, in the first mode of operation, is configured to receive a second control signal comprising at least one of following parameters: cyclic time period for the DRX and DTX mode, number of cyclic time periods for the DRX and DTX mode, cyclic time period for the DTX mode, or number of cyclic time periods for the DTX mode.

7. The user device according claim 1,
wherein the transceiver, in the first mode of operation, is configured to provide a base band signal,
wherein the transceiver is configured to upconvert the base band signal to a RF signal, and
wherein the transceiver, in the second mode of operation, is configured to transmit the upconverted base band signal.

8. A network node in a wireless communication system, the network node comprising:
a processor configured to determine a first mode of operation or a second mode of operation for a user device, wherein the user device in the first mode of operation is configured to receive and transmit RF signals, and the user device in the second mode of operation is configured to transmit RF signals and not to receive RF signals; and
a transceiver coupled with the processor and is configured to transmit a first control signal to the user device, the first control signal comprising an operation mode command indicating the determined first mode of operation or the second mode of operation.

9. The network node according to claim 8,
wherein the transceiver is configured to receive beacon signals from the user device;
wherein the processor is configured to determine at least one resource allocation parameter based on at least one measurement of the beacon signals; and
wherein the transceiver is configured to transmit an allocation signal to the user device, the allocation signal comprising the at least one resource allocation parameter.

10. The network node according to claim 9,
wherein the transceiver is configured to receive at least one other measurement from other network nodes, the at least one other measurement being associated with the beacon signals from the user device; and
wherein the processor is configured to determine the at least one resource allocation parameter based on the at least one measurement and the at least one other measurement.

11. The network node according claim 8,
wherein the first mode of operation is a DRX and DTX mode and the second mode of operation (M2) is a DTX mode;
wherein the processor is configured to determine at least one DTX parameter; and
wherein the transceiver is configured to transmit a second control signal to the user device, the second control signal comprising the DTX parameter.

12. The network node according to claim 11,
wherein the transceiver is configured to signal the DTX parameter to other network nodes.

13. A method for a user device comprising a transceiver, the method comprising:
operating the transceiver in a first mode of operation in which the transceiver is configured to receive and transmit RF signals, or
operating the transceiver in a second mode of operation in which the transceiver is configured to transmit RF signals and not to receive RF signals.
